(19) United States
(12) Patent Application Publication
(10) Pub. No.: US 2026/0093084 A1
(43) Pub. Date: Apr. 2, 2026

(54) HIGH SPEED ENTRANCE TERMINATION

(71) Applicant: Berk-Tek LLC, New Holland, PA (US)

(72) Inventors: Michael Connaughton, Holly Springs, NC (US); David P. Ford, Cary, NC (US); Dean Lipke, Mill Creek, WA (US); Jackson William Raney, Bothell, WA (US)

(21) Appl. No.: 18/903,250

(22) Filed: Oct. 1, 2024

(51) Int. Cl. G02B 6/44

(52) U.S. Cl. CPC G02B 6/4471

(57) ABSTRACT

An optical termination tray is configured to connect multiple pairs of fiber optic cables simultaneously by connecting ferrules that terminate the cables without the use of an outer connector bodies. The optical termination tray can connect the ferrules of fiber optic cables without the need for outer connector housings to be terminated on the respective cables. The tray can connect multiple pairs of cables in this manner, reducing the amount of time needed to connect multiple fiber optic cables at high-density installation areas while maintaining acceptable insertion loss characteristics.

### TECHNICAL FIELD

The disclosed subject matter relates generally to fiber optic cable connectivity hardware.

### BACKGROUND

Fiber optic cables are often used as a medium for telecommunication and computer networking due to their flexibility, high data capacity, and immunity to interference. Since light is used as the data transmission medium, fiber optic cables can carry data over long distances with little attenuation relative to electrical data transmission. Fiber optic cables are used in many types of applications and contexts, including data centers, local area networks that use optical transceivers, corporate intranets that deploy optical pathways for high-speed transmission of data on a corporate campus, or other such data transmission applications.

To interconnect multiple sets of fiber optic cables at high-density locations requiring large numbers of optical fibers, such as hyperscale data center entrance locations or internet exchange data centers, each fiber cable is typically terminated with a connector and pairs of cables are connected through an adapter. Fiber cables can also be connected using a fusion splice, whereby pairs of individual fibers are spliced end-to-end.

The foregoing is merely intended to provide an overview of patch panel design considerations relevant to the solutions described herein. Problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide an optical termination tray that can connect multiple pairs of fiber optic cables simultaneously using bodiless ferrule connection. The optical termination tray can connect the ferrules of fiber optic cables without the need for connector bodies to be terminated on the respective cables. Since the tray is capable of connecting multiple pairs of cables in this manner, using the tray, or multiple instances of the tray, at high-density installation areas can reduce the amount of time needed to connect multiple fiber optic cables while maintaining acceptable insertion loss characteristics.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a perspective view of an example fiber connector assembly in which a fiber cable is terminated by a ferrule which itself is housed within a connector housing or body.

FIG. 2 is a side view of two connector assemblies plugged into respective sides of an adapter.

FIG. 3 is a close-up view of connected ferrules of respective two connector assemblies.

FIG. 4 is a perspective view of an example optical termination tray.

FIG. 5 is a top view of the optical termination tray.

FIG. 6 is a close-up rear view of the ferrule attachment mechanisms formed on the slidable sub-tray of the optical termination tray.

FIG. 7 is a close-up front view of the ferrule attachment mechanisms.

FIG. 8 is a close-up view of one of the levers of the slidable sub-tray.

FIG. 9 is a close-up view of the ferrule attachment mechanisms formed on the fixed sub-tray.

FIG. 10 is a close-up view of one end of the fixed sub-tray illustrating an engagement hole formed near the front corner of the fixed sub-tray.

FIG. 11a is a perspective view of the optical termination tray with the slidable sub-tray in a disengaged position.

FIG. 11b is a perspective view of the optical termination tray being advanced toward the fixed sub-tray.

FIG. 11c is a perspective view of the optical termination tray in which the levers of the slidable sub-tray are used to advance the slidable sub-tray to the engaged position.

FIG. 12 is a close-up view of a lever of the slidable sub-tray in the fully engaged position.

FIG. 13 is a close-up view of a first set of ferrules engaged with a second set of ferrules after the slidable sub-tray has been advanced.

FIG. 14 is an example optical cable bundle.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Some reference numbers used herein to label illustrated components are suffixed with letters to delineate different instances of a same or similar component. In general, if a reference number without an appended letter is used within this disclosure, the descriptions ascribed to the reference number are to be understood to be applicable to all instances of that reference number with or without an appended letter unless described otherwise.

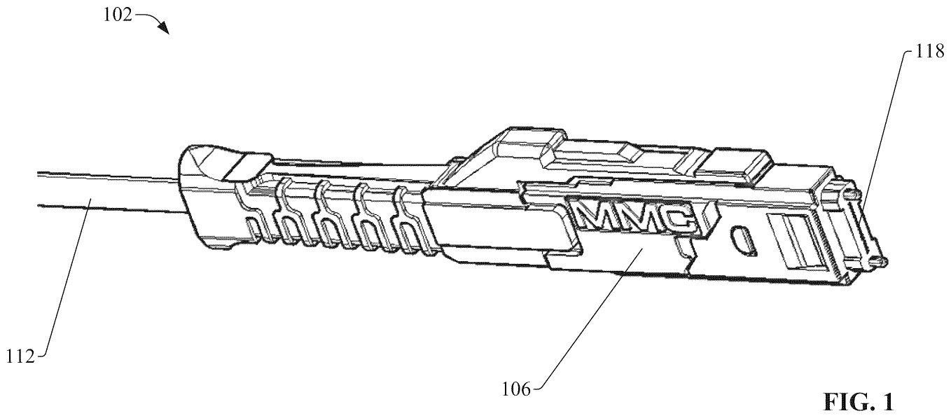

In many fiber optic connectivity applications, fiber optic cables, each comprising multiple individual optical fibers, are terminated by a connector, and pairs of fiber optic cables are communicatively connected by plugging these the connectors of the respective cables to respective sides of an adapter. FIG. 1 is a perspective view of an example fiber connector assembly 102 in which a fiber cable 112 is terminated by a ferrule 118 which itself is housed within a connector housing 106 or body. In the illustrated example, the ferrule 118 is a TMT ferrule, which is housed within an MMC connector housing 106. Fiber cable 112 may be, for example, a ribbon cable comprising multiple individual fibers, which are terminated on the rear side of the ferrule 118 inside the connector housing 106.

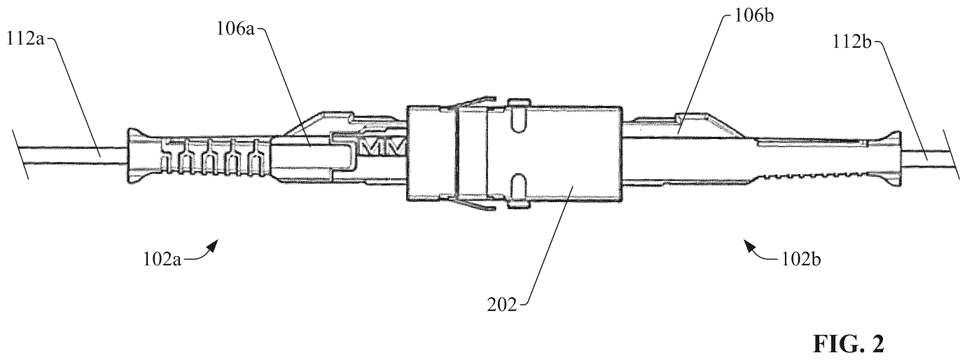

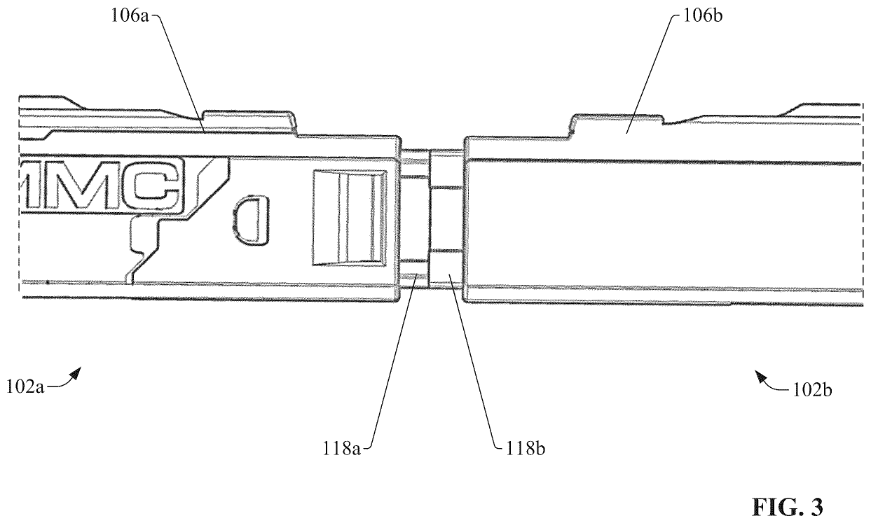

FIG. 2 is a side view of two connector assemblies 102a and 102b plugged into respective sides of an adapter 202. When the connector housings 106 (or connector housings) are plugged into respective sides of the adapter 202, the two ferrules 118 (not visible in FIG. 2) housed within the respective connector housings 106a and 106b make aligned contact with one another, thus establishing a communicative connection between corresponding optical fibers of the fiber cables 112a and 112b via the aligned and connected ferrules 118. FIG. 3 is a close-up view of the connected ferrules 118a and 118b of the two connector assemblies 102a and 102b with the adapter 202 omitted for visibility. In some connector and ferrule designs, the ferrules 118a, 118b are designed to retract into their corresponding connector housings 106a, 160b when pressure is applied to the front faces of the ferrules 118a, 118b. Springs that act on the rear sides of the ferrules 118a and 118b (not visible) maintain a compression force that acts against this retraction, applying forward pressure on the ferrules 118a, 118b while retracted to ensure a secure abutment of the front faces of the ferrules 118a, 118b against one another while the connector housings 106a, 106b are engaged with the adapter 202. Interconnecting multiple sets of fiber optic cables 112 at high-density locations requiring large numbers of optical fibers using this connectivity approach can be excessively time consuming, since pairs of fiber cables 104 must be individually connected together through an adapter 202 one pair at a time.

As an alternative to the use of connector housings 106 and ferrules 118, fiber cables 112 can be connected using fusion splicing, whereby pairs of individual fibers—one from each fiber cable 112—are spliced end-to-end. This approach also consumes excessive time and labor, since installers must individually splice each pair of fibers to be connected, across many fiber cables 112.

To address these and other issues, one or more embodiments described herein provide an optical termination tray that can connect multiple pairs of fiber optic cables 112 simultaneously using bodiless ferrule connection. The optical termination tray can connect the ferrules 118 of multiple fiber optic cables 112 without the need for connector housings 106 to be terminated on the respective cables 112. Since the tray is capable of connecting multiple pairs of cables 112 in this manner, using the tray, or multiple instances of the tray, at high-density installation areas can reduce the amount of time needed to connect multiple fiber optic cables 112 while maintaining acceptable insertion loss characteristics.

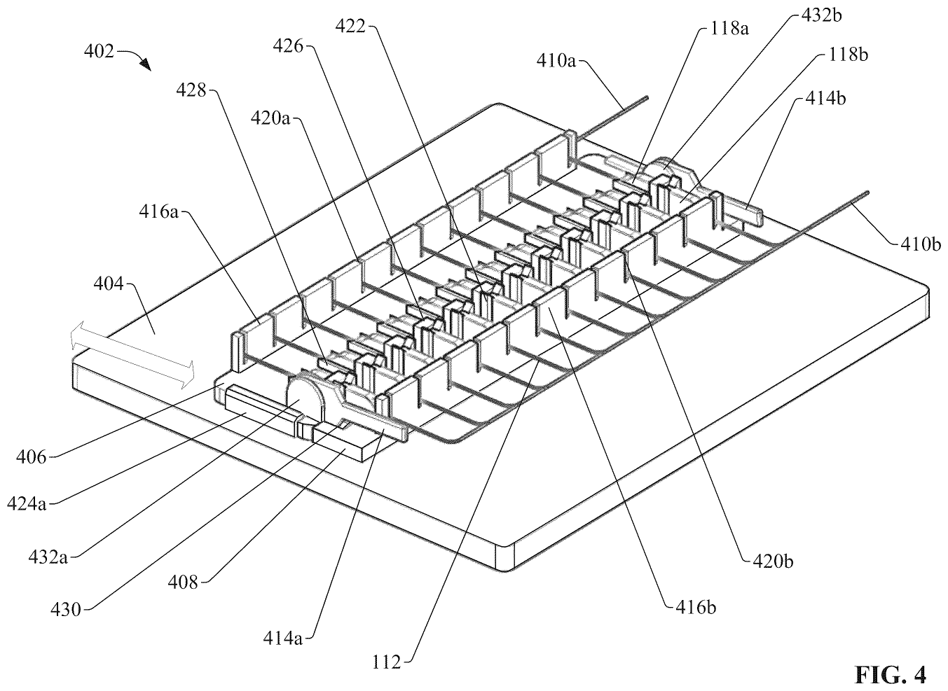

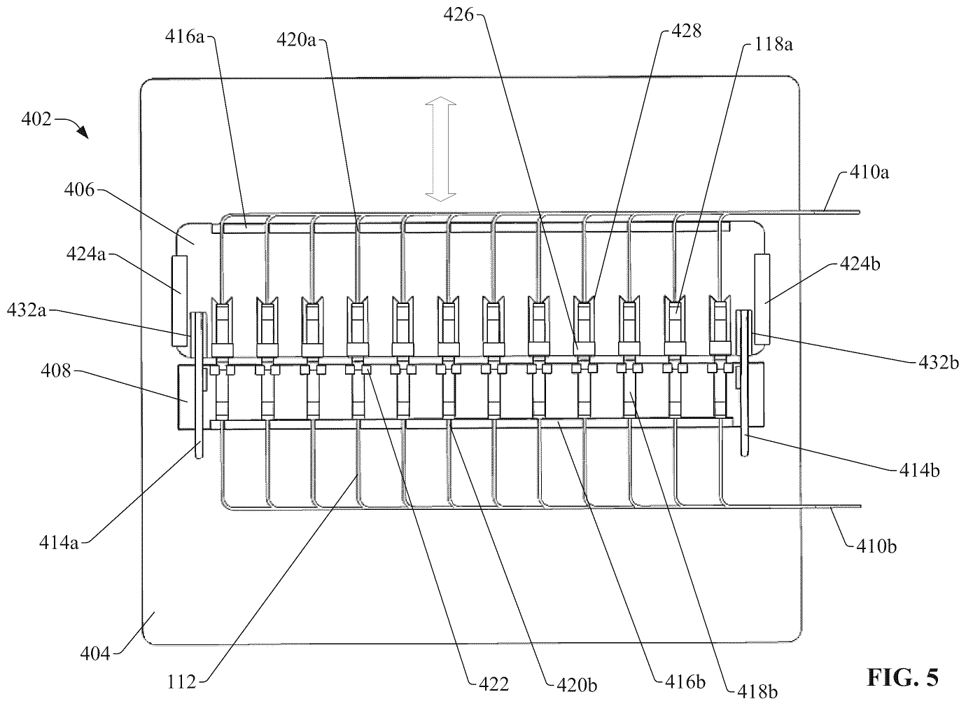

FIG. 4 is a perspective view of an example optical termination tray 402 according to one or more embodiments. FIG. 5 is a top view of the optical termination tray 502. In the example configuration depicted in FIGS. 4 and 5, two fiber groups 410a and 410b, each comprising multiple fiber cables 112, are routed to the optical termination tray 402 and broken into respective sets of 12 fiber cables 112 (e.g., ribbon cables or another type of fiber cable). The optical termination tray 402 is used to communicatively connect fiber cables 112 of one groups 410a to corresponding fiber cables 112 of the other group 410b without terminating the fiber cables 112 with the typical type of connectors comprising housings or bodies (e.g., connector housings 106 illustrated in FIGS. 1-3). Instead, each fiber cable 112 is terminated only with a ferrule 118, such as a TMT ferrule, and the optical termination tray 402 is used to establish a ferrule-to-ferrule connection between opposing fiber cables 112 without the use of the typical connector comprising a housing 106.

Optical termination tray 402 comprises a flat base 404 on which are mounted a fixed sub-tray 408 and a slidable sub-tray 406. Fixed sub-tray 408 is mounted in a fixed position on the base 404, while slidable sub-tray 406 can be slid axially toward or away from the fixed sub-tray 408 in the directions indicated by the arrow in FIGS. 4 and 5. The two lateral edges of the slidable sub-tray 406 (that is, the left and right edges as oriented in FIG. 5) are held to the base 404 by parallel guide rails 424a and 424b formed on the base 404. These guide rails 424a and 424b hold the slidable sub-tray 406 against the base 404 and prevent lateral movement of the slidable sub-tray 406 while allowing the slidable sub-tray 406 to slide axially toward and away from the fixed sub-tray 408.

The fixed sub-tray 408 and slidable sub-tray 406 each comprise ferrule attachment mechanisms or elements (to be discussed in more detail below) that allow a set of ferrules 118 to be mounted to the facing edge each of the sub-trays 408, 406 (that is, the edge facing the opposing sub-tray 408, 406). In the illustrated example, a first fiber group 410a is routed to the optical termination tray 402 and separated into a first set of 12 fiber cables 112 which are each terminated with a ferrule 118a, and the ferrules 118a of this first set of fiber cables 112 are mounted on the slidable sub-tray 406. Similarly, a second fiber group 410b is routed to the optical termination tray 402 and separated into a second set of 12 fiber cables 112 which are each terminated with a ferrule 118b, and the ferrules 118b of this second set of cables 112 are mounted on the fixed sub-tray 408. Although the example optical termination tray 402 illustrated in FIGS. 4 and 5 depicts sub-trays 406, 408 that are each configured to hold 12 ferrules 118 and associated fiber cables 112, embodiments of the optical termination tray 402 can be designed to hold and terminate substantially any number of ferrules 118, which are mounted in a row along the facing edges of the sub-trays 408, 406.

An entry wall 416 is formed along the rear edge of each of the sub-trays 406 and 408 (that is, along the edge of the sub-tray 406, 408 opposite the edge that faces the opposing sub-tray 406, 408). Entry wall 416a is formed along the rear edge of the slidable sub-tray 406, while entry wall 416b is formed along the rear edge of the fixed sub-tray 408. A number of vertical slots 420 equal to the number of ferrules 118 that each sub-tray 406, 408 is designed to hold are formed in each entry wall 416. Each slot 420 runs from the top edge of the entry wall 416 to a point near the bottom of the entry wall 416, such that the slots 420 are open at the top edges of the entry walls 416. Each slot 420 is substantially aligned with a corresponding ferrule attachment mechanism formed on the sub-tray 406, 408. The separated fiber cables 112 can be inserted into these slots 420 when their corresponding ferrules 118 are installed on the sub-trays 406, 408 to assist in maintaining separation and organization of the fiber cables 112 on the optical termination tray 402.

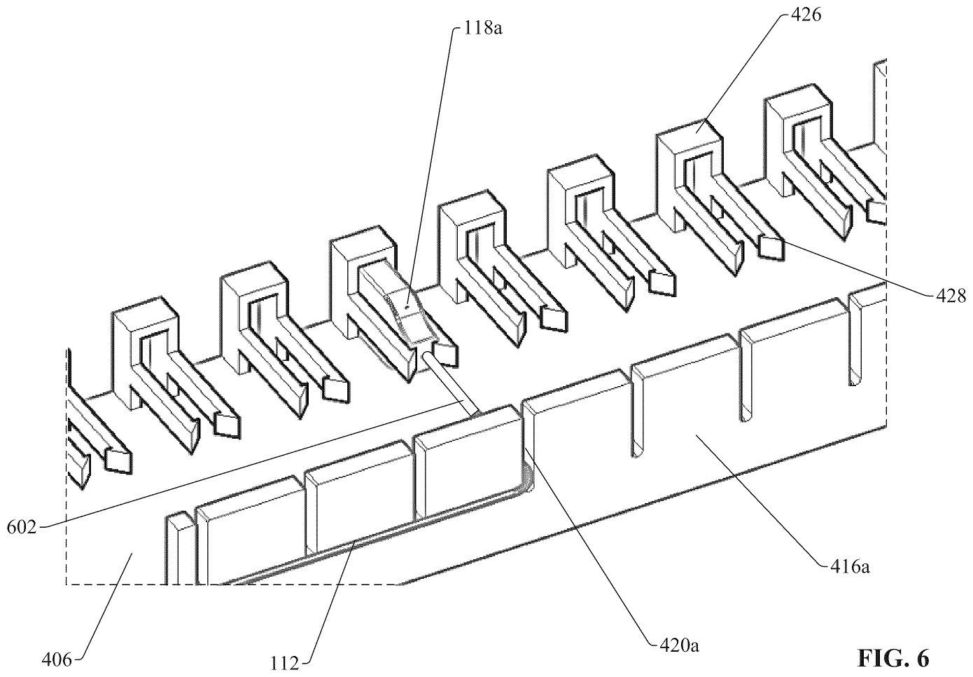

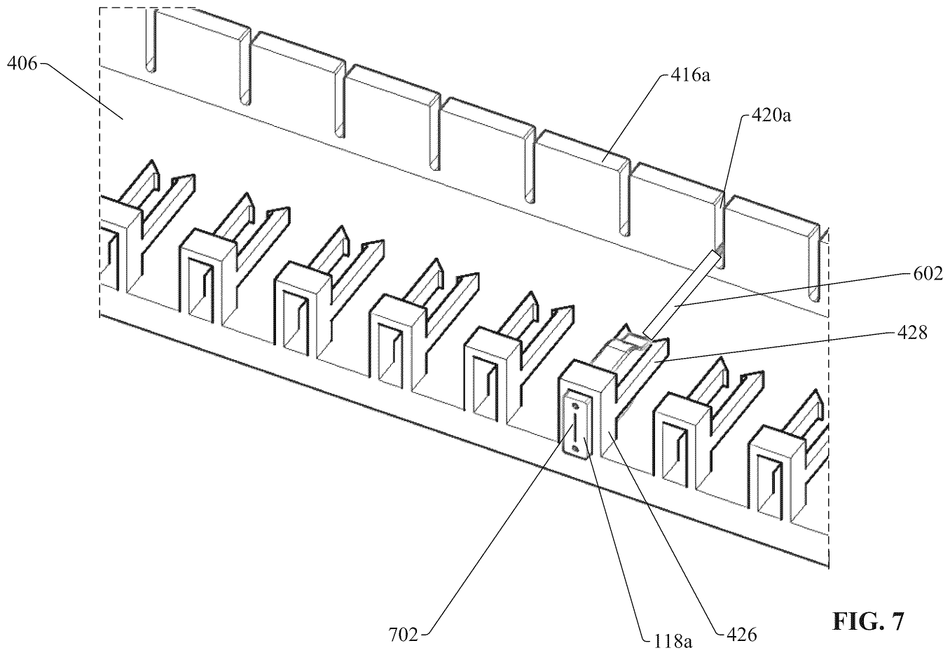

FIG. 6 is a close-up rear view of the ferrule attachment mechanisms formed on the slidable sub-tray 406. FIG. 7 is a close-up front view of these ferrule attachment mechanisms. Each ferrule attachment mechanism on the slidable sub-tray 406 comprises a rectangular arch 426 having an opening with dimensions that conform those of the profile of a ferrule 118a (e.g., a TMT ferrule or another type of ferrule) and a pair of opposing elastic clamps 428 that extend horizontally from the two vertical edges, respectively, of the rectangular arch 426 toward the rear edge of the slidable sub-tray. Inward-facing hooks are formed on the ends of the elastic clamps 428 and are configured to retain a ferrule 118a inserted between the pair of clamps 428. A row of these ferrule attachment mechanisms is formed along the front edge of the slidable sub-tray 406 (that is, the edge that faces the fixed sub-tray 408) such that the front sides of the rectangular arches 426 are substantially flush with the front edge.

A ferrule 118a that terminates the end of a fiber cable 112 can be inserted front-first between a pair of elastic clamps 428 and through the rectangular arch 426. As the ferrule 118a is inserted, the elastic clamps 428 flex outwardly to allow insertion of the ferrule 118a. The ferrule 118a is advanced through the rectangular arch 426 until the rear side of the ferrule 118a is moved past the hooks formed on the ends of the elastic clamps 428, allowing the spring force of the elastic clamps 428 to snap the hooks into place behind the ferrule 118a, retaining the ferrule 118a in the attachment mechanism. While installed in the ferrule attachment mechanism, the front face of the ferrule 118a protrudes slightly beyond the front edge of the slidable sub-tray 406 and is held in alignment with an opposing ferrule 118b mounted on the fixed sub-stray 408 (to be described in more detail below). If desired, a spring 602 can be installed on the rear side of each ferrule 118a, such that the corresponding fiber cable 112 traverses through the spring 602 and the spring 602 resides between the ferrule 118 and the entry wall 416a while the ferrule 118a is installed on the optical termination tray 402. This spring 602 can be compressed between the rear side of the ferrule 118 and the entry wall 416a, producing a compression force that acts against the rear side of the ferrule 118a, ensuring that the front face of the ferrule 118a protrudes forward with appropriate pressure. Although the illustrated examples depict an embodiment of the optical termination tray 402 in which the ferrule attachment mechanisms hold the ferrules 118 in a vertical orientation whereby the optical fibers are oriented linearly in a perpendicular (or top-to-bottom) direction relative to the surface of the tray 402, some embodiments of the optical termination tray 402 can comprise ferrule attachment mechanisms that hold the ferrules 118 in a horizontal orientation whereby the optical fibers are oriented linearly in a substantially parallel (or left-to-right) orientation relative to the surface of the tray 402. As shown in FIGS. 6 and 7, the fiber cable 112 that is terminated by the ferrule 118a passes through the slot 420a of the entry wall 416a that aligns with the ferrule attachment mechanism. The ferrule 118a can be removed from the attachment mechanism by manually separating the elastic clamps 428 to disengage the clamps 428 from the ferrule 118a and removing the ferrule 118a from the rectangular arch 426.

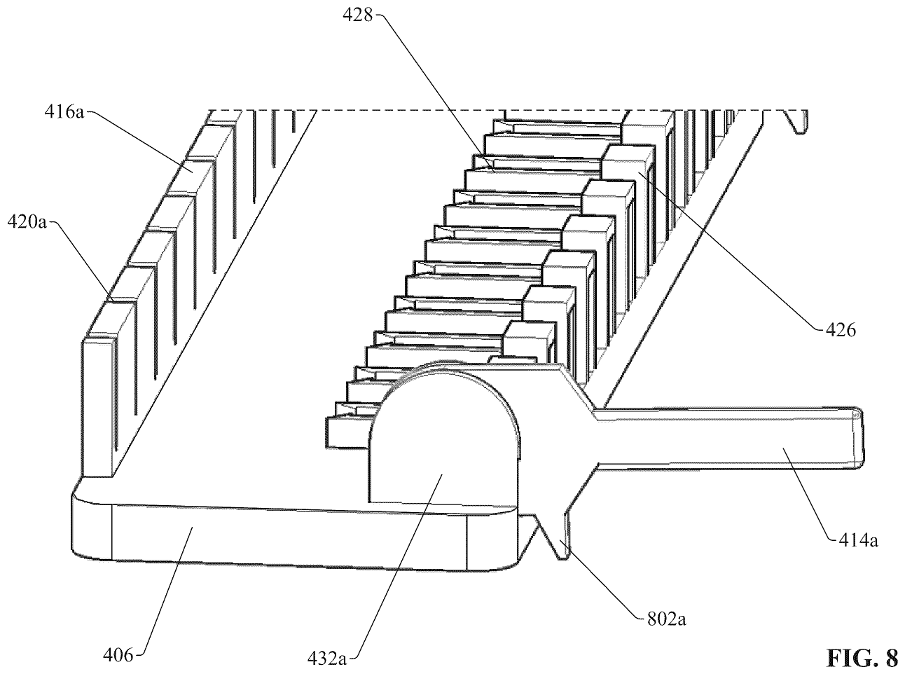

Two levers 414a and 414b are mounted on respective lateral ends of the slidable sub-tray 406 (that is, near the edges that are adjacent to the facing and rear edges of the slidable sub-tray 406). FIG. 8 is a close-up view of one of the levers 414a. Each lever 414 is rotatably attached to a fulcrum 432 disposed near the front edge of the slidable sub-tray 406, with each of the two fulcrums 432a, 432b disposed near a respective end of the slidable sub-tray 406. A post 802 protrudes from the bottom of the lever 414 at a location that allows the post 802 to be rotated to a location in front of the facing edge of the slidable sub-tray 406 when the lever 414 is rotated forward to an engaged position. The lever 414a can pivot about the fulcrum 432a, which allows the posts 802 to be moved between a disengaged position (by rotating the lever 414 upward) and the engaged position (by rotating the lever 414 downward), as will be described in more detail below.

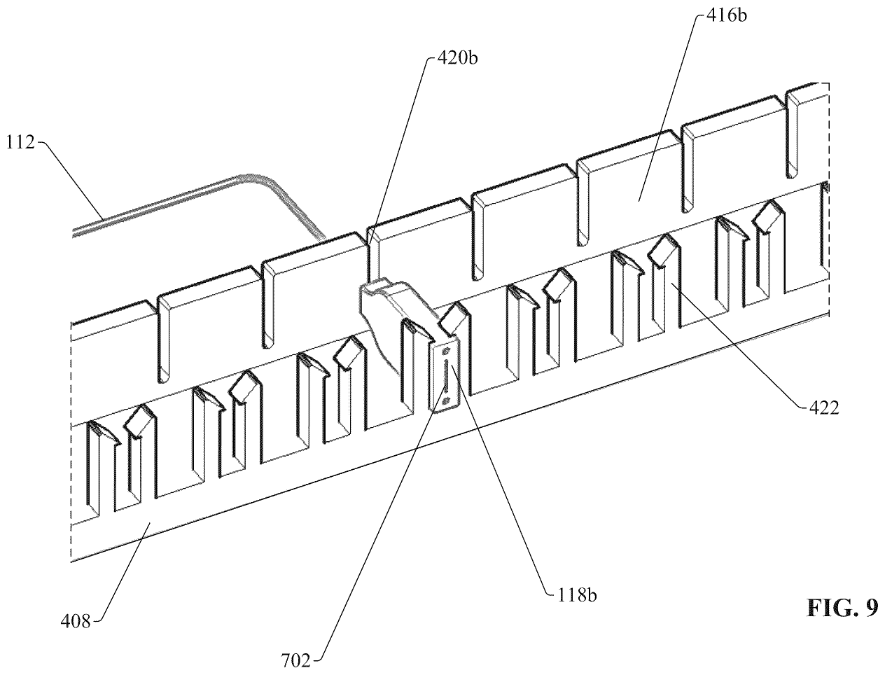

FIG. 9 is a close-up view of the ferrule attachment mechanisms formed on the fixed sub-tray 408. Each attachment mechanism on the fixed sub-tray 408 comprises a pair of elastic clamps 422 that project upward or vertically from the top surface of the fixed sub-tray 408. A row of these pairs of elastic clamps 422 are formed along the front edge of the fixed sub-tray 408 (that is, the edge of the sub-tray 408 that faces the slidable sub-tray 406). Similar to the elastic clamps 428 on the slidable sub-tray 406, inward-facing hooks are formed on the ends of each pair of elastic clamps 422. A ferrule 118b can be inserted bottom-first into the gap between the pair of elastic clamps 422. In the case of the TMT ferrules 118b depicted in FIG. 9, which have a rectangular profile, a narrow side of the ferrule 118b is interested into the gap between the clamps 422. As a ferrule 118b is inserted into the gap between a pair of elastic clamps 422, the elastic clamps 422 flex outward to allow entry of the ferrule 118b. The ferrule 118b can be pushed into the gap between a pair of elastic clamps 422 until the bottom of the ferrule 118b abuts against the top surface of the fixed sub-tray 408. The distance between the top surface of the fixed sub-tray 108 and the hooks on the ends of the pair of elastic clamps 422 is approximately equal to the height of the ferrule 118b, such that the top edge of the ferrule 118b snaps below the hooks when the bottom of the ferrule 118b is abutted against the top surface of the fixed sub-tray 408, holding the ferrule 118b in place.

The distance between the elastic clamps 422 and the entry wall 416b of the fixed sub-tray 408 is such that, when the rear of the ferrule 118b is abutted against the entry wall 416b while the ferrule 118b is held between the pair of elastic clamps 422, the front face of the ferrule 118b protrudes slightly beyond the front edge of the fixed sub-tray 408. Springs on the rear side of the ferrule 118b can act against the entry wall 416 to apply forward pressure to the ferrule 118b while installed between the elastic clamps 422, ensuring that an appropriate amount of forward pressure is applied to the ferrule 118b while installed. Each pair of elastic clamps 422 holds a ferrule 118b in alignment with an opposing ferrule 118a mounted on the slidable sub-tray 406.

Although the fixed sub-tray 408 is depicted herein as comprising vertically oriented elastic clamps 422 while the slidable sub-tray 406 is depicted as comprising horizontally oriented elastic clamps 428, these orientations can be reversed in some embodiments, such that the elastic clamps 422 of the fixed sub-tray 408 are oriented horizontally while the elastic clamps 422 of the slidable sub-tray 406 are oriented vertically. Alternatively, both sub-trays 406 and 408 may comprise ferrule attachment mechanisms having a common vertical or horizontal orientation in some embodiments. Regardless of differences in the vertical or horizontal orientations of elastic clamps 422, 428, the orientation of ferrules 118a, 118b on sub-trays 408, 406, respectively, will be the same to ensure proper orientation of the optical fibers 702 disposed therein.

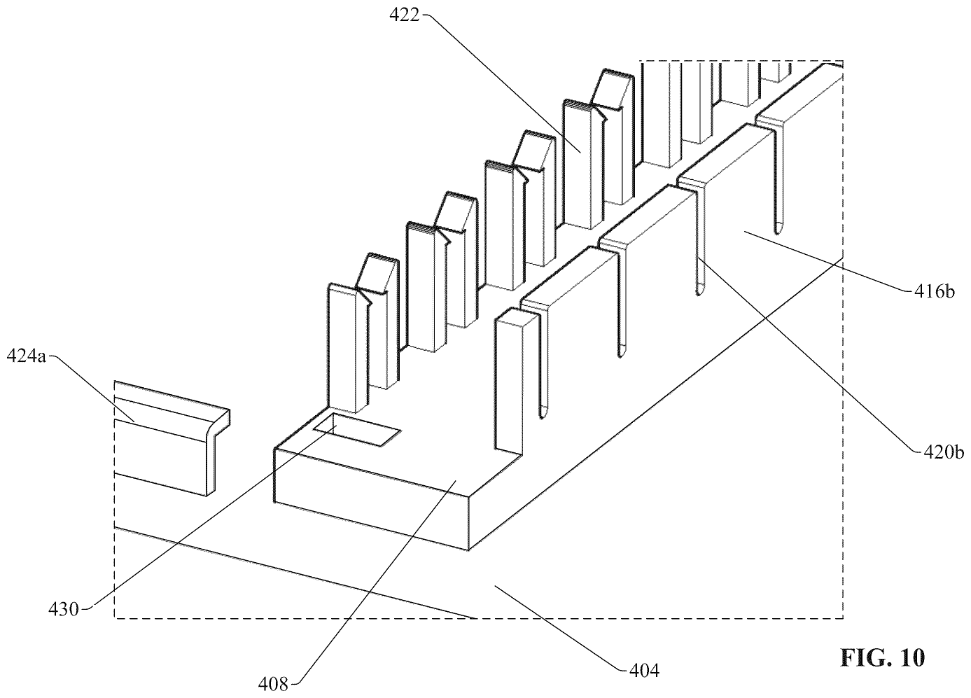

FIG. 10 is a close-up view of one end of the fixed sub-tray 408 illustrating an engagement hole 430 formed near the front corner of the fixed sub-tray 408. Engagement holes 430 are formed near the two ends, respectively, of the fixed sub-tray 408 near the front edge of the fixed sub-tray 408. These engagement holes 430 are designed to receive the posts 802 on the levers 414 of the slidable sub-tray 406 to thereby engage the two sub-trays 406 and 408 as well as their corresponding ferrules 118a and 118b, as will be described in more detail below.

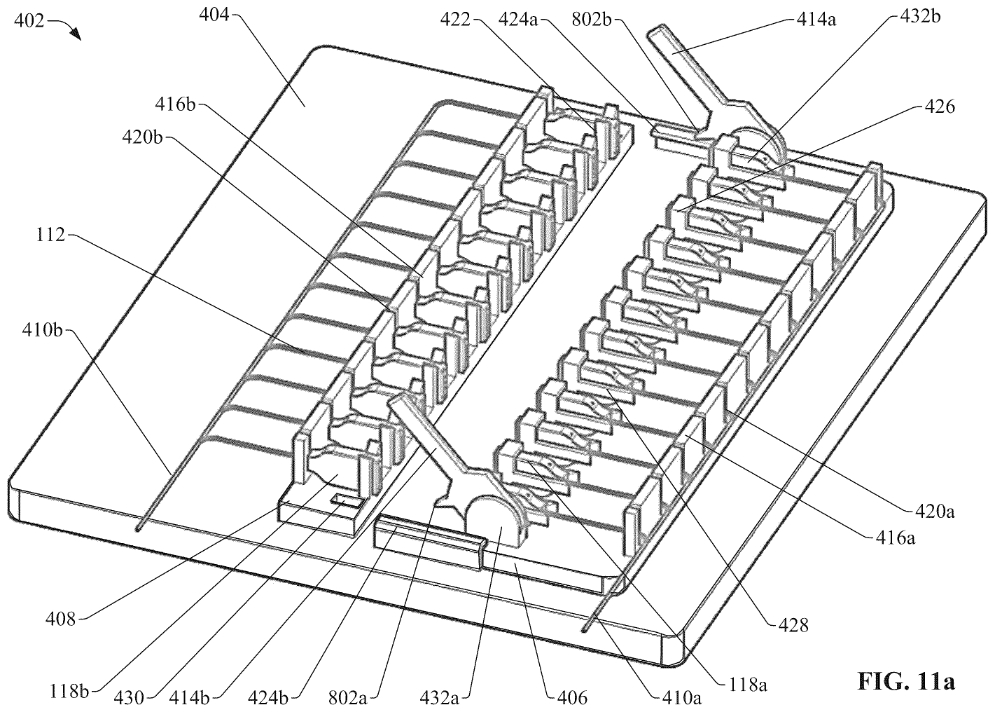

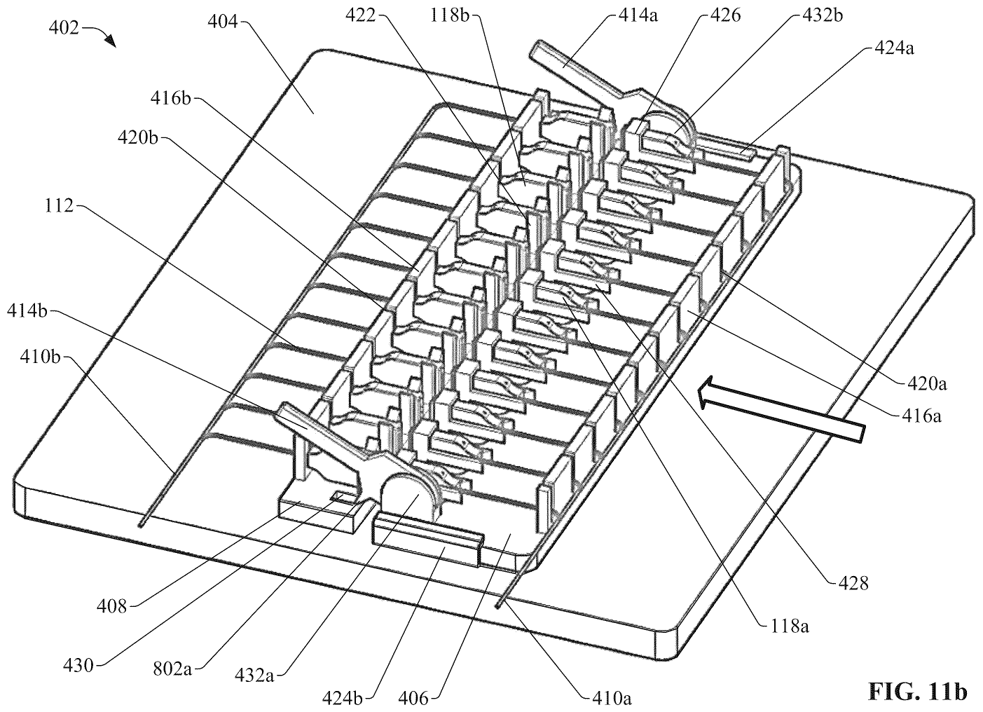

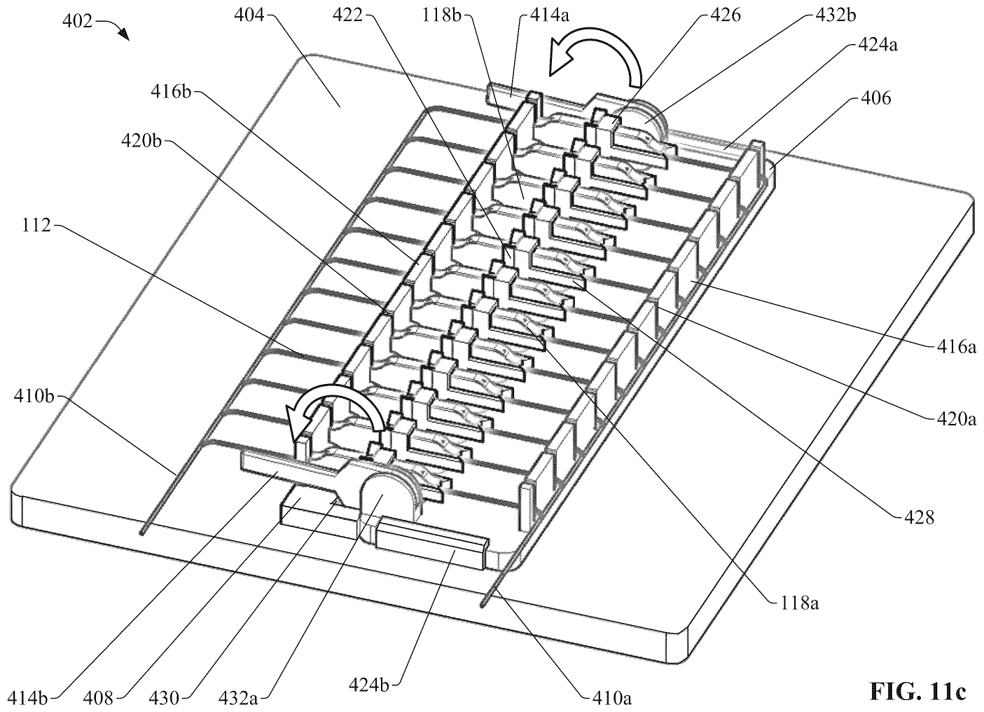

FIGS. 11a-11c are perspective views of the optical termination tray 402 illustrating simultaneous engagement of a first set of ferrules 118a mounted on the slidable sub-tray 406 with a second set of ferrules 118b mounted on the fixed sub-tray 408. FIG. 11a depicts the slidable sub-tray 406 in the disengaged position, whereby the slidable sub-tray 406 has been slid away from the fixed sub-tray 408. The ferrules 118a of a first set of fiber cables 112 from fiber group 410a have been installed in the ferrule attachment mechanisms (rectangular arches 426 and elastic clamps 428) of the slidable sub-tray 406, while ferrules 118b of a second set of fiber cables 112 from fiber group 410b have been installed in the ferrule attachment mechanisms (elastic clamps 422) of the fixed sub-tray 408, as described above.

To engage the ferrules 118a on the slidable sub-tray 406 with corresponding ferrules 118b of the fixed sub-tray 408, the slidable sub-tray 406 is advanced toward the fixed sub-tray 408, as indicated by the arrow in FIG. 11b. The guide rails 424a and 424b limit movement of the slidable sub-tray 406 to the axial direction (toward or away from the fixed sub-tray 408) and prevent lateral movement of the slidable sub-tray 406, ensuring that the two sets of ferrules 118a and 118b remain aligned as the slidable sub-tray 406 is moved toward the fixed sub-tray 408. The slidable sub-tray 406 is pushed toward the fixed sub-tray 408 until the ferrules 118a on the slidable sub-tray 406 make contact with the corresponding ferrules 418b on the fixed sub-tray 408.

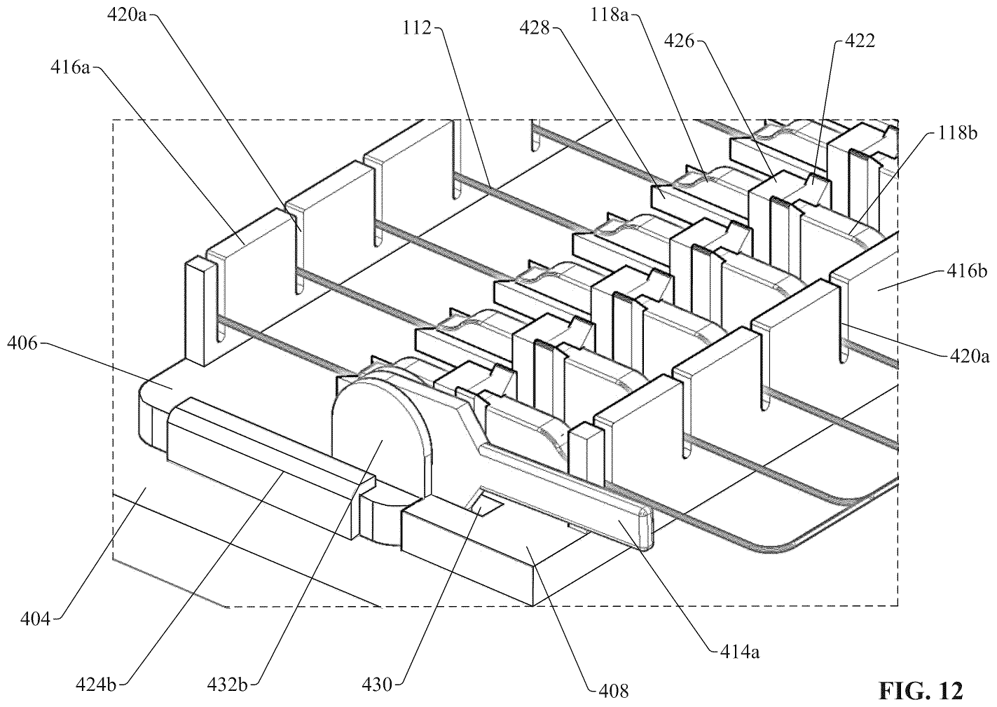

To fully engage ferrules 118a with ferrules 118b, the levers 414a and 414b on the respective ends of the slidable sub-tray 406 can be simultaneously rotated downward about their respective fulcrums 432a and 432b, as indicated by the arrows in FIG. 11c. This causes the posts 802a and 802b to engage with the engagement holes 430 on the respective ends of the fixed sub-tray 408. The leverage afforded by levers 414a and 414b advances the slidable sub-tray 406 toward the fixed sub-tray 408 to the final engaged position, applying a uniform forward axial force across the row of ferrules 118a. This uniform axial force causes the ferrules 118a on the slidable sub-tray 406 to fully engage with the corresponding ferrules 118b on the fixed sub-tray 408, ensuring uniform termination across the rows of ferrules 118a and 118b. FIG. 12 is a close-up view of lever 414a in the fully engaged position.

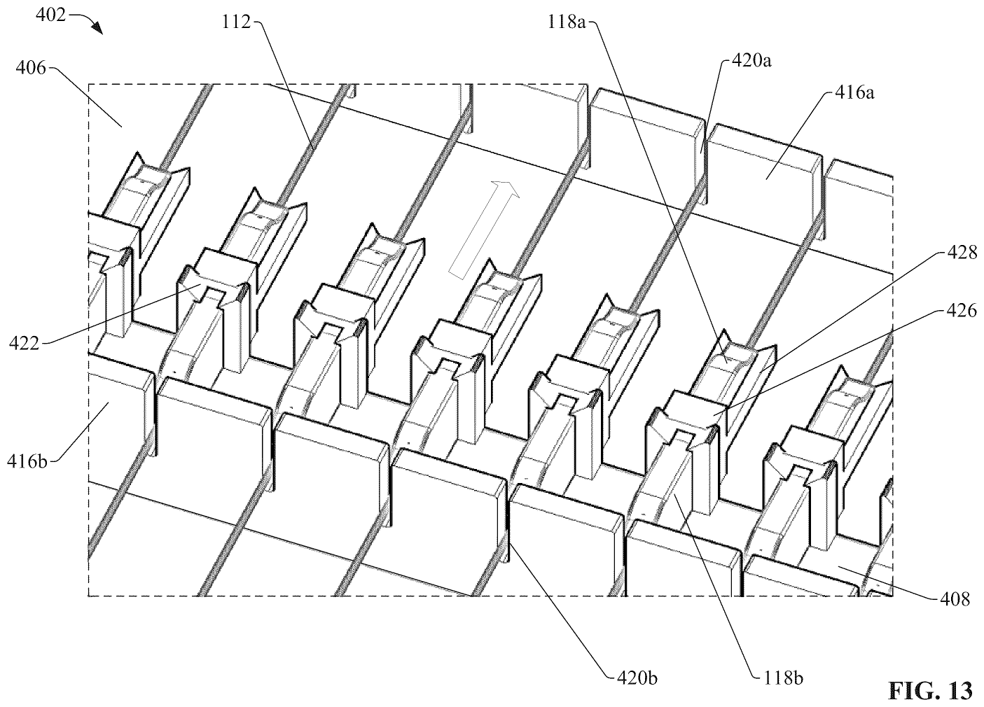

FIG. 13 is a close-up view of ferrules 118a engaged with ferrules 118b after the slidable sub-tray 406 has been advanced to the engaged position and the ferrules 118a and 118b have been fully engaged using levers 414a and 414b. The uniform force applied across the row of ferrules 118a using levers 414a and 414b ensures that all ferrules 118a on the slidable sub-tray 406 fully connect with the ferrules 118a on the fixed sub-tray 408. The ferrules 118a on the slidable sub-tray 406 can also be disconnected from the ferrules 118b on the fixed sub-tray 408 simultaneously by pulling the slidable sub-tray 406 away from the fixed sub-tray 408, which applies a uniform pulling force across the row of ferrules 118a.

The design of the ferrule attachment mechanisms on the slidable sub-tray 406 also allows selected ferrules 118a on the slidable sub-tray 406 to be individually disconnected from their corresponding ferrules 118b on the fixed sub-tray 408 without the need to mass disconnect the entire row of ferrules 118a. This can be achieved by separating the flexible clamps 428 that hold the selected ferrule 118a in place and withdrawing the ferrule 118a from the rectangular arch 426 in the direction indicated by the arrow. The selected ferrule 118a (or another ferrule 118) can also be individually reengaged by inserting the ferrule 118 between the pair of elastic clamps 428 and engaging the ferrule 118a with its corresponding ferrule 118b without the need to perform a mass connection action using the slidable sub-tray 406.

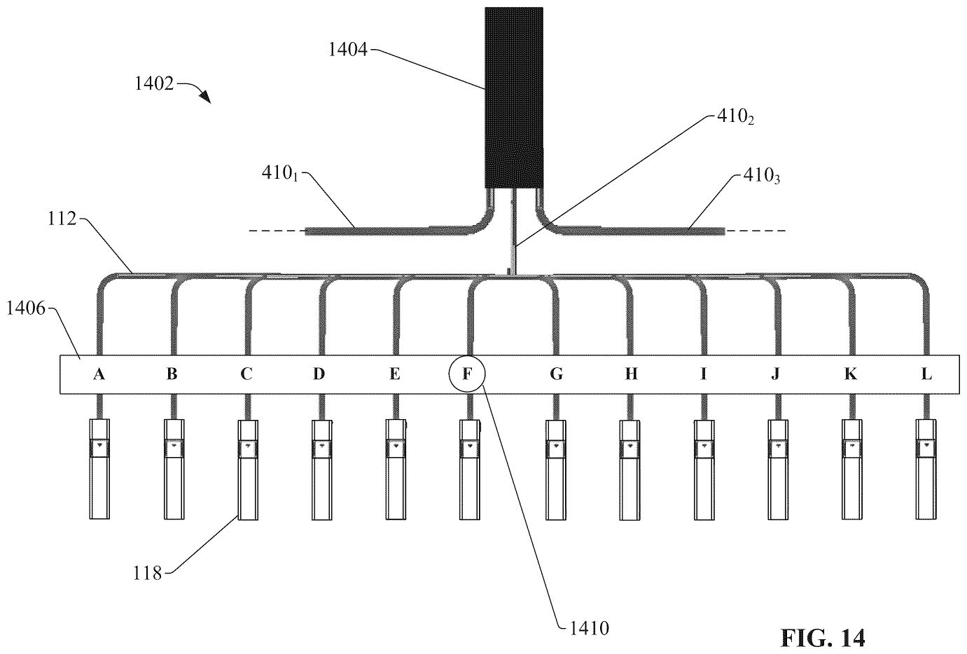

To further simplify installation and termination of large numbers of fiber cables 112 using optical termination trays 402, a pre-fabricated fiber cable bundle can be provided that organizes and labels fiber cables 112 for convenient installation on optical termination trays 402. FIG. 14 is an example optical cable bundle 1402 according to one or more embodiments. Optical cable bundle 1402 comprises a trunk cable 1404 in which multiple fiber cables 112 (e.g., ribbon cables) are bundled. At the manufacturing stage, sets of these fiber cables 112 are grouped together into n cable groups 410₁-410n (where n is an integer) with each group 410 comprising a number of fiber cables 112 equal to the number of ferrules 118 that can be held by each of the sub-trays 406, 408 of the optical termination tray 402. Each fiber cable 112 of each cable group 410 is pre-terminated with a ferrule 118. In the example illustrated in FIG. 14, the individual cables 112 of cable group 410₂ are depicted. The example cable group 410₂ comprises a grouped set of 12 optical fiber cables 112, making the group 4102 compatible with the example 12-ferrule optical termination tray 402 illustrated in FIGS. 4-13. Although FIG. 14 depicts only three cable groups 410₁-410₃, trunk cables 1404 can be fabricated to include any number of such cable groups 410₁-410ₙ, providing any number of prepared cable groups 410 ready for termination on optical termination trays 402.

Each cable group 410 can be furcated to maintain separation of the groups 410₁-410ₙ and to ensure that each group 410 is held together during the cable routing process. However, the furcation for a given group 410 does not extend all the way to the ferrules 118 of that group 410. Instead, specified lengths of the ends of the cables 112 within a group 410 remain separated beyond the end of their group's furcation, and a length of adhesive tape 1406, or a similar supportive or adhesive substrate, is applied across the cables 112 of the group 410 near the ferrules 118 of the cables 412. The adhesive tape 1406 holds the cables 112 of the group 410 in a specific cable ordering or sequence to assist installers in maintaining consistent and correct termination between an incoming group of cables 112 and an outgoing group of cables 112 at the optical termination tray 402. Applying tape 1406 across the cables 112 ensures that cables 112 of each group 410 are maintained in this specific order as the trunk cable 1404, or selected fiber groups 410, are being routed to the optical termination tray 402 during installation (e.g., as the trunk cable 1404 and the exposed portions of the cable groups 410₁-410ₙ are being pulled to their termination locations using a pulling eye or another cable pulling mechanism).

The tape 1406 can also assist with the cable manufacturing process by maintaining organization of the cables 112 of each group 410 as the groups 410₁-410ₙ are rolled together prior to attaching a pulling eye (not shown) to the trunk cable 1404. Tape 1406 can also provide additional strain relief as the groups 410₁-410ₙ are being pulled to their termination locations. To further assist with the manufacturing process, the lengths of the separated portions of the fiber cables 112 (that is, the portions that extend beyond the furcation of the group 410) can be staggered in some embodiments. This can yield a smaller overall diameter when the cables 112 of the group 410 are rolled together since the ferrules 118 will be staggered with one another.

Additionally, labels 1410 can be printed on the adhesive tape 1406 at locations near their corresponding cables 112. In the illustrated example, the 12 cables 112 of group 4102 are labeled A through L. However, the labels 1410 printed on tape 1406 can conform to any suitable labeling convention. Once a cable group 410 is routed to an optical termination tray 402, the labels 1410 can assist the installer in determining the correct termination locations on the sub-tray 408 or 406 for the respective cables 112 (that is, which of the ferrule attachment mechanisms on the slidable sub-tray 406 or the fixed sub-tray 408 each cable 112 of the group 410 is to be mounted to). For example, when a group 410 of fiber cables 112 from an incoming trunk cable 1404 is mounted to the slidable sub-tray 406 in the order in which the fiber cables 112 are held by the adhesive tape 1406 (and in accordance with the sequence indicated by labels 1410), similar labels 1410 on another group 410 of cables 112 from an outgoing trunk cable 1404 can convey to the installer the correct sequence in which to mount the cables 112 of the outgoing trunk cable 1404 on the fixed sub-tray 408 to ensure correct terminations between the two groups 410 of cables 112.

The optical termination tray 402 illustrated in FIGS. 4-13 and described above facilitates simultaneous connection of multiple fiber cables 112 without the need for the cables 112 to be terminated with a typical connector comprising a housing 106. Instead, the optical termination tray 402 itself acts as the connector housing to complete the termination of corresponding fiber cables 112. This approach can yield a smaller cross-section for fiber trunks and a smaller total area required for fiber terminations relative systems that require the fiber cables 112 to be terminated with connectors. Since each of the sub-trays 406 and 408 can retain multiple ferrules 118, the optical termination tray 402 also allows multiple fiber cables 112 to be connected and disconnected simultaneously, while still allowing individual fiber cables 112 to be disconnected without disconnecting all cables 112 on the tray 402. These features allow dozens of fiber cables 112 to be interconnected quickly without inhibiting the ability to access and disconnect individual pairs of ferrules 118. Multiple optical termination trays 402 can be installed in a fiber containment enclosure or other structure, such as a patch panel or patch deck, to yield a system for connecting large numbers of optical fibers quickly and easily. The optical termination tray 402 can be manufactured to have substantially any shape or footprint that is compatible with the enclosure or deck in which the tray 402 will be installed.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. An optical termination tray, comprising:
a base;
a fixed sub-tray disposed on a top surface of the base and comprising a first set of ferrule attachment elements;
a slidable sub-tray disposed on the top surface of the base and comprising a second set of ferrule attachment elements that is aligned with the first set of ferrule attachment elements,
wherein the slidable sub-tray is configured to slide toward and away from the fixed sub-tray.

2. The optical termination tray of claim 1, wherein a first set of fiber optic ferrules mounted to the first set of ferrule attachment elements engage with a second set of ferrules mounted to the second set of ferrule attachment elements in response to the slidable sub-tray being slid toward the fixed sub-tray to an engaged position.

3. The optical termination tray of claim 2, further comprising a lever configured to pivot about a fulcrum attached to the slidable sub-tray,
wherein, while the slidable sub-tray is in a position in which the first set of fiber optic ferrules is in contact with the second set of fiber optic ferrules, pivoting the lever toward the fixed sub-tray causes a post on the lever to engage with a hole formed in the fixed sub-tray and causes the slidable sub-tray to advance toward the fixed sub-tray to the engaged position.

4. The optical termination tray of claim 2, wherein
the first set of ferrule attachment elements is mounted along a front edge of the fixed sub-tray, and
the fixed sub-tray comprises an entry wall formed along a rear edge of the fixed sub-tray, the entry wall comprising slots that are aligned with the first set of ferrule attachment elements and that are configured to hold respective fiber cables attached to the first set of fiber optic ferrules.

5. The optical termination tray of claim 2, wherein
the second set of ferrule attachment elements are mounted along a front edge of the slidable sub-tray, and
the slidable sub-tray comprises an entry wall formed along a rear edge of the slidable sub-tray, the entry wall comprising slots that are aligned with the second set of ferrule attachment elements and that are configured to hold respective fiber cables attached to the second set of fiber optic ferrules.

6. The optical termination tray of claim 1, further comprising a pair of guide rails mounted to the top surface of the base,
wherein the pair of guide rails is configured to guide motion of the slidable sub-tray toward and away from the fixed sub-tray in an axial direction and to prevent movement of the slidable sub-tray in a lateral direction.

7. The optical termination tray of claim 2, wherein a ferrule attachment element, of the second set of ferrule attachment elements, comprises a pair of elastic clamps configured to hold a fiber optic ferrule, of the second set of fiber optic ferrules, and to permit disengagement and removal of the fiber optic ferrule without disengaging other fiber optic ferrules of the second set of fiber optic ferrules.

8. The optical termination tray of claim 7, wherein the pair of elastic clamps is oriented horizontally.

9. The optical termination tray of claim 1, wherein the first set of ferrule attachment elements and the second set of ferrule attachment elements are configured to hold fiber optic ferrules that terminate respective fiber optic ribbon cables.

10. The optical termination tray of claim 1, wherein the base is configured to be installed in a fiber optic enclosure or patch panel.

11. A system, comprising:
a fixed sub-tray mounted on a flat base;
a first row of ferrule attachment mechanisms mounted on a first edge of the fixed sub-tray;
a slidable sub-tray slidably mounted to the flat base; and
a second row of ferrule attachment mechanisms mounted on a second edge of the slidable sub-tray facing the first edge,
wherein
the first row of ferrule attachment mechanisms is substantially aligned with the second row of ferrule attachment mechanisms, and
the slidable sub-tray is slidable toward and away from the fixed sub-tray.

12. The system of claim 11, wherein, while a first set of fiber optic ferrules is held by the first row of ferrule attachment mechanisms and a second set of fiber optic ferrules is held by the second row of ferrule attachment mechanisms, sliding the slidable sub-tray toward the fixed sub-tray to an engaged position causes the first set of fiber optic ferrules to engage with the second set of fiber optic ferrules.

13. The system of claim 12, wherein
the slidable sub-tray comprises a lever configured to pivot about a fulcrum, and
while the slidable sub-tray is in a position in which the first set of fiber optic ferrules is in contact with the second set of fiber optic ferrules, pivoting the lever toward the fixed sub-tray causes a post on the lever to engage with a hole formed in the fixed sub-tray and causes the slidable sub-tray to advance toward the fixed sub-tray to the engaged position.

14. The system of claim 11, wherein
the fixed sub-tray comprises an entry wall formed along a rear edge of the fixed sub-tray opposite the first edge, and
the entry wall comprises slots that are aligned with the first row of ferrule attachment mechanisms and that are configured to hold respective fiber cables attached to the first set of fiber optic ferrules.

15. The system of claim 11, wherein
the slidable sub-tray comprises an entry wall formed along a rear edge of the slidable sub-tray opposite the second edge, and
the entry wall comprises slots that are aligned with the second row of ferrule attachment mechanisms and that are configured to hold respective fiber cables attached to the second set of fiber optic ferrules.

16. The system of claim 11, wherein
the slidable sub-tray is held on the flat base by a pair of guide rails, and
the pair of guide rails is configured to guide a sliding movement of the slidable sub-tray toward and away from the fixed sub-tray in an axial direction and to prevent movement of the slidable sub-tray in a lateral direction.

17. The system of claim 12, wherein
a ferrule attachment mechanism, of the second row of ferrule attachment mechanisms, comprises a pair of elastic clamps configured to hold a fiber optic ferrule of the second set of fiber optic ferrules, and
the pair of elastic clamps permits disengagement and removal of the fiber optic ferrule without disengaging other fiber optic ferrules of the second set of fiber optic ferrules.

18. The system of claim 11, wherein the first row of ferrule attachment mechanisms and the second row of ferrule attachment mechanisms are configured to hold fiber optic ferrules that terminate respective fiber optic ribbon cables.

19. A fiber optic system, comprising:
a trunk cable comprising at least one group of fiber optic cables, wherein the fiber optic cables of the group are terminated by ferrules; and
adhesive tape applied across the fiber optic cables of the at least one group, wherein the adhesive tape maintains an ordering of the fiber optic cables.

20. The fiber optic system of claim 19, wherein labels are printed on the adhesive tape that identify respective cables of the fiber optic cables.
